(19) United States
(12) Patent Application Publication
(10) Pub. No.: US 2014/0226988 A1
(43) Pub. Date: Aug. 14, 2014

(54) BIDIRECTIONAL OPTICAL DATA COMMUNICATIONS MODULE HAVING REFLECTIVE LENS

(71) Applicant: AVAGO TECHNOLOGIES GENERAL IP (SINGAPORE) PTE. LTD., Singapore (SG)

(72) Inventors: Bing Shao, Sunnyvale, CA (US); Xiaozhong Wang, Cupertino, CA (US); Ye Chen, San Jose, CA (US); Seng-Kum Chan, Santa Clara, CA (US)

(73) Assignee: Avago Technologies General IP (Singapore) Pte. Ltd, Singapore (SG)

(21) Appl. No.: 13/765,398

(22) Filed: Feb. 12, 2013

(51) Int. Cl. H04B 10/40

(52) U.S. Cl. CPC H04B 10/40
USPC 398/139

(57) ABSTRACT

An optical transceiver module includes at least one light source configured to emit an optical transmit signal having a transmit wavelength, at least one light detector configured to detect an optical receive signal having a receive wavelength, and an optical coupling system having at least one reflective-and-focusing (RAF) lens and at least one optical filter that discriminates the first and second wavelengths. The optical coupling system defines a transmit path and a receive path, each formed within one or more contiguous regions of the optical coupling system.

### BACKGROUND

In data communications systems, it is often useful to modularize interface electronics and other interface elements in a data communication module. For example, in an optical data communication system, an optical data transceiver module may include a light source such as a laser, and a light detector such as a photodiode, and may also include driver and receiver circuitry associated with the laser and photodiode. The laser and associated circuitry convert electrical signals that the module receives via electrical contacts into optical signals that the module outputs via one or more optical fibers. The photodiode and associated circuitry convert optical signals received via the one or more optical fibers into electrical signals that the module outputs via the electrical contacts.

An optical data transceiver module may be of a type that transmits a modulated transmit signal having a first wavelength via an optical fiber and receives a modulated receive signal having a second wavelength via the same optical fiber. Such a module generally includes a wavelength-selective filter (also referred to as a beam splitter) to separate the transmit signal and the receive signal.

An optical data transceiver module generally also includes an optical coupling system that defines one or more optical paths that couple the laser and the photodiode to the one or more optical fibers. An optical coupling system may include optical elements such as one or more lenses, reflectors, filters, etc. One type of conventional optical coupling system includes a lens block having a refractive lens with a convex surface facing the end face of the optical fiber. The refractive lens is separated from the end face of the fiber by an air gap. This air gap creates two interfaces at which there is a mismatch between indices of refraction: one interface where the lens block and the air gap meet, and another interface where the air gap and the fiber end face meet. Fresnel reflection occurs at these two interfaces. Fresnel reflection contributes to insertion loss, which can be problematic, especially in power-limited systems. Fresnel reflection can also contribute to optical crosstalk, which is also undesirable, especially in bi-directional communications links.

### SUMMARY

Embodiments of the present invention relate to an optical transceiver module comprising at least one light source configured to emit an optical transmit signal having a transmit wavelength, at least one light detector configured to detect an optical receive signal having a receive wavelength, and an optical coupling system having at least one reflective-and-focusing (RAF) lens and at least one optical filter.

In an exemplary embodiment, the optical coupling system defines a transmit path and a receive path, each formed within one or more contiguous regions of the optical coupling system. The one or more contiguous regions within which the transmit path is formed are transparent to the transmit wavelength, and the one or more contiguous regions within which the receive path is formed are transparent to the receive wavelength. A first optical filter can be substantially reflective either to the receive wavelength or, in other embodiments, to the transmit wavelength. In embodiments in which the first optical filter is substantially reflective to the receive wavelength, the first optical filter is substantially transparent to the transmit wavelength. Accordingly, in embodiments in which the first optical filter is substantially reflective to the transmit wavelength, the first optical filter is substantially transparent to the receive wavelength. The term “substantially” in this context means greater than or equal to about 50 percent.

An optical fiber port is included in both the transmit path and the receive path. Likewise, the RAF lens is included in both the transmit path and the receive path. The RAF lens is optically aligned with the optical fiber axis of the optical fiber port. A region of the optical coupling system in the transmit path and the receive path between the optical fiber port and RAF lens is devoid of air gaps to help minimize Fresnel reflection. The first optical filter is also included in both the transmit path and the receive path. A light source that emits the optical transmit signal is aligned along an input of the transmit path, and a light detector that detects the optical receive signal is aligned along an output of the receive path.

In the exemplary embodiment, a method for optical communication in the above-described optical transceiver module includes: the light source emitting the optical transmit signal such that the optical transmit signal is incident upon an input of the transmit path; the optical coupling system propagating the optical transmit signal along the transmit path from the input of the transmit path to the RAF lens via the first optical filter; the RAF lens reflecting and focusing the optical transmit signal to form a focused transmit signal that propagates from the RAF lens to an end face of an optical fiber retained in the optical fiber port without propagating through an air gap; the end face of the optical fiber emitting an optical receive signal having a receive wavelength such that the optical receive signal is incident upon the RAF lens; the optical coupling system propagating the optical receive signal along the receive path from the RAF lens to a output of the receive path via the first optical filter; and the first light detector detecting the optical receive signal emitted from the output of the receive path.

Other systems, methods, features, and advantages will be or become apparent to one with skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

FIG. 1 is a perspective view of a dual-wavelength optical transceiver module, in accordance with an exemplary embodiment of the present invention.

FIG. 2 is a sectional view taken on line 2-2 of FIG. 1.

FIG. 3 is a schematic illustration of optical paths and elements shown in FIG. 2.

FIG. 4 is a schematic illustration of optical paths and elements of a dual-wavelength bi-directional optical transceiver module, in accordance with another exemplary embodiment of the invention.

### DETAILED DESCRIPTION

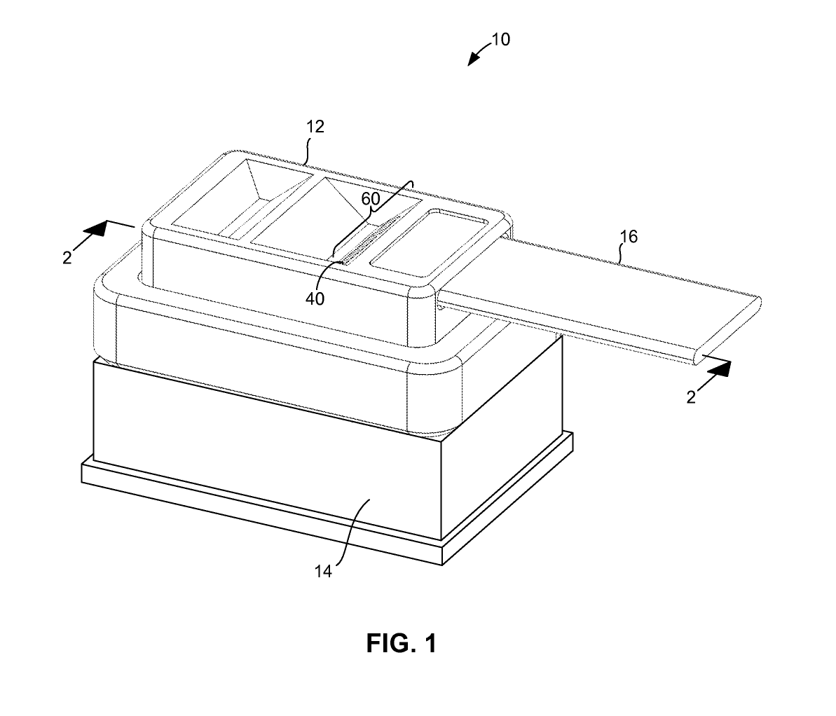

As illustrated in FIG. 1. in an illustrative or exemplary embodiment of the invention, an optical transceiver module 10 includes an optical coupling system 12 and a transceiver body 14. An optical ribbon cable 16 is coupled to optical coupling system 12 in a manner described in further detail below.

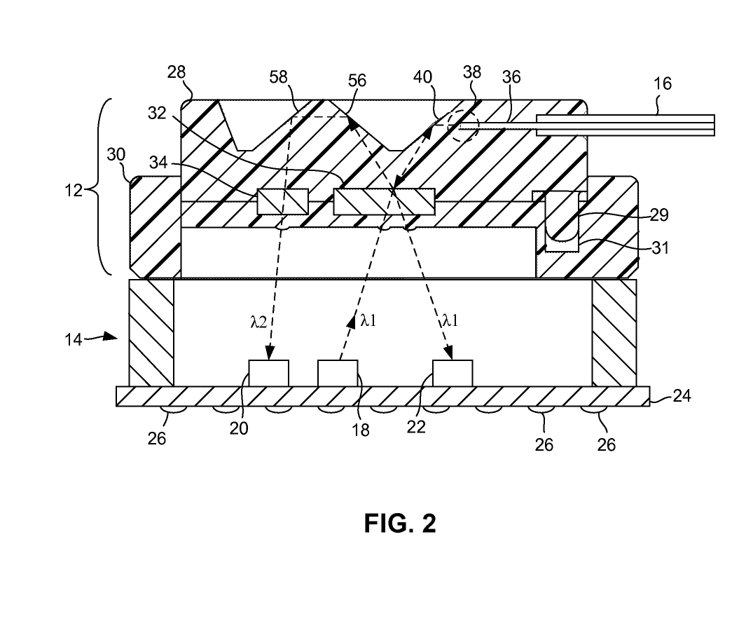

As illustrated in FIG. 2, transceiver body 14 houses a light source 18, a primary light detector 20, and a monitor light detector 22, all mounted on an upper portion of a printed circuit board 24 or similar electronic subassembly. Light source 18 can comprise, for example, a vertical cavity surface-emitting laser (VCSEL). Light detectors 20 and 22 can comprise, for example, photodiodes such as positive-intrinsic-negative (PIN) diodes. The lower portion of printed circuit board 24 includes an array of electrical contacts 26. Although not shown for purposes of clarity, electronic circuitry, such as driver circuitry that drives light source 18 and receiver circuitry that processes electronic signals produced by light detectors 20 and 22, are also mounted on printed circuit board 24 or other such electronic subassembly. In operation, light source 18 responds to data signals received from a group of electrical contacts 26 (via the driver circuitry) by producing an optical transmit signal modulated to correspond to the data. Also, in operation, primary light detector 20 responds to an optical receive signal that is incident upon it by producing data signals corresponding to the data with which the optical receive signal is modulated. The receiver circuitry (not shown) processes such data signals produced by primary light detector 20 and provides the resulting signals to a group of electrical contacts 26. The optical transmit signal emitted by light source 18 has a first wavelength or “transmit wavelength” (λ1) that is different from the second wavelength or “receive wavelength” (λ2) of the optical receive signal that primary light detector 20 detects.

Optical coupling system 12 is mounted on transceiver body 14. Optical coupling system 12 includes an upper portion 28 and a lower portion 30. One or more pins 29 extend from upper portion 28 into corresponding bores 31 in lower portion 30 to help align upper and lower portions 28 and 30. Sandwiched between upper portion 28 and lower portion 30 are a first optical filter 32 and a second optical filter 34. That is, a lower surface of upper portion 28 and an upper surface of lower portion 30 have recesses that accommodate first optical filter 32 and second optical filter 34. Upper and lower portions 28 and 30 are made of a material that is transparent to both the transmit wavelength and the receive wavelength. An example of a suitable material is polyetherimide (PEI), such as SABIC's ULTEM® brand PEI. Other suitable materials may include polycarbonate-based plastics.

The end face of an optical fiber 36 of optical ribbon cable 16 is retained within a bore in upper portion 28. (Optical ribbon cable 16 includes other such optical fibers, but only an exemplary one is shown for purposes of clarity.) Also, although not shown for purposes of clarity, the bore is filled with a refractive index-matching material, such as a suitable optical epoxy. That is, the index-matching material fills any voids between optical fiber 36 and the bottom of the bore, such that the interface between the end face of optical fiber 36 and upper portion 28 defines an optical fiber port 38 that is devoid of air gaps. In an exemplary embodiment in which Ultem® PEI has a refractive index value of, for example, about 1.63, and optical fiber 36 has a refractive index value of, for example, about 1.49, the refractive index-matching material can have a refractive index value that is greater than or equal to 1.49 and less than or equal to 1.63. Optical fiber port 38 has a fiber axis (not shown for purposes of clarity) that represents the optical axis at the end face of optical fiber 36 along which optical signals can enter and exit optical fiber 36 in the manner described below.

Upper portion 28 of optical coupling system 12 includes a reflective-and-focusing (RAF) lens 40. RAF lens 40 can be, for example, of a type known as a total internal reflection (TIR) lens. RAF lens 40 reflects light incident upon it from first optical filter 32 and focuses such light upon optical fiber port 38. Conversely, RAF lens 40 reflects light incident upon it from optical fiber port 38 and reflects such light toward first optical filter 32. Note that RAF lens 40 is unitary with the remainder of upper portion 28. That is, RAF lens 40 is molded into the same continuous region or block of material (e.g., ULTEM® PEI) of which the remainder of upper portion 28 is formed.

In conventional optical coupling systems that include refractive lenses, the interfaces between lenses and other optical elements, such as the end face of an optical fiber, cannot be omitted because to do so would inhibit the intended optical effect of the optical coupling system. The reason for this is that a refractive lens relies on a refractive index mismatch created by a curved dielectric-to-air (e.g., plastic-to-air or glass-to-air) interface to achieve the desired optical effect, i.e., refraction of light. The above-described RAF lens 40 does not rely upon an air gap to achieve its optical (focusing) effect but rather achieves its optical effect by shifting the phase front reshaping surface into the same continuous region of material (e.g., ULTEM® PEI) of which the remainder of upper portion 28 is formed. For convenience, such a continuous, homogeneous region of solid material may be referred to herein as a “solid block” of material. The absence of an air gap between RAF lens 40 and optical fiber port 38 inhibits Fresnel reflection, thereby helping to minimize insertion loss and optical crosstalk. The term “optical crosstalk” refers to light that the end face of optical fiber 36 (of fiber port 38) may undesirably reflect back upon the path from which it arrived (toward RAF lens 40), as well as to light that monitor light detector 22 may undesirably reflect back upon the path from which it arrived. As described below, such optical crosstalk is inhibited not only by RAF lens 40 but also by second optical filter 34, as described below.

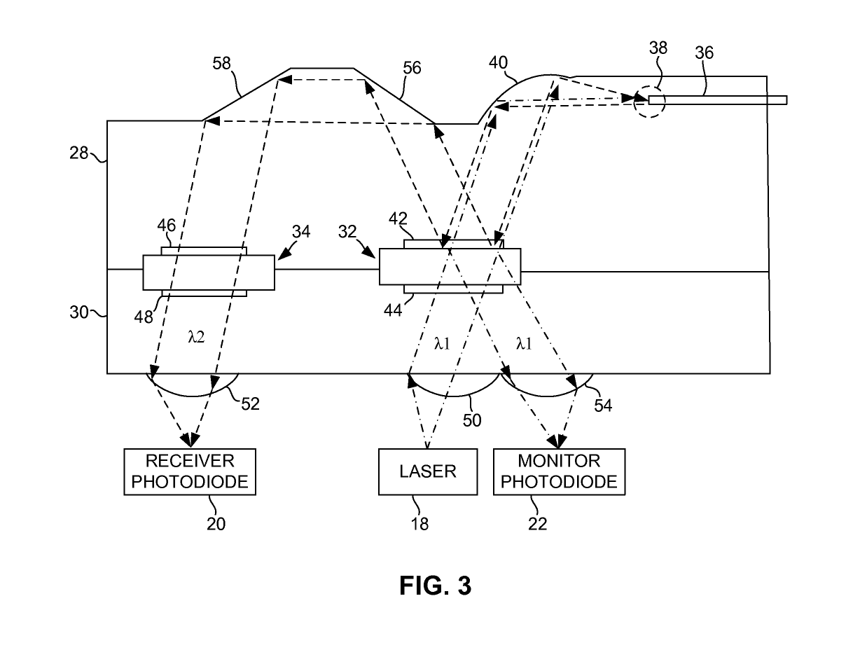

As further illustrated in more of a schematic manner in FIG. 3, one interface of first optical filter 32 (i.e., one of its two planar sides) can be attached within a correspondingly-shaped recess in upper portion 28 with a refractive index-matching material 42, such as a suitable optical epoxy. Likewise, the other interface of first optical filter 32 (i.e., the other of its two planar sides) can be attached within a correspondingly-shaped recess in lower portion 30 with such a refractive index-matching material 44. Similarly, the two interfaces of second optical filter 34 can be attached within correspondingly-shaped recesses in upper and lower portions 28 and 30, respectively, with refractive index-matching material 46 and 48, respectively. Alternatively, in other embodiments (not shown), there can be air gaps between the sides or other interfaces of such optical filters and adjacent portions of the optical coupling system.

Optical coupling system 12 defines a transmit path and a receive path, which are respectively differentiated in FIG. 3 by two types of broken line. The transmit path defines a path through optical coupling system 12 along which the optical transmit signal is capable of propagating. The transmit path has a transmit path input defined in the exemplary embodiment by a lens 50 formed on a surface of lower portion 30. Light source 18 is aligned (along its optical axis) with lens 50 and thus aligned with the transmit path input. Similarly, the receive path defines a path through optical coupling system 12 along which the optical receive signal is capable of propagating. The receive path has a receive path output defined in the exemplary embodiment by another lens 52 formed on a surface of lower portion 30. Primary light detector 20 is aligned (along its optical axis) with lens 52 and thus aligned with the receive path output.

The transmit path includes the above-referenced transmit path input (defined by lens 50), at least portion of first optical filter 32, RAF lens 40, and optical fiber port 38. Thus, in operation, the transmit signal emitted by light source 18 is incident on lens 50 and propagates along the transmit path through a region of lower portion 30 to first optical filter 32. First optical filter 32 is substantially transparent to the transmit wavelength (λ1). Therefore, a substantial proportion (e.g., at least about 50 percent) of the optical energy of the transmit signal is transmitted through first optical filter 32. The portion of the transmit signal that is transmitted through first optical filter 32 continues to propagate along the transmit path through a region of upper portion 28 and is incident on RAF lens 40. RAF lens 40 reflects this portion of the transmit signal and focuses it upon the end face of optical fiber 36 at optical fiber port 38. Note that the transmit path includes a region of lower portion 30 between lens 50 and first optical filter 32, a region of upper portion 28 between first optical filter 32 and RAF lens 40, and a region of upper portion 28 between RAF lens 40 and optical fiber port 38. In the exemplary embodiment, all of these regions of optical coupling system 12 are contiguous and devoid of air gaps. Thus, in the exemplary embodiment, the entire transmit path from the transmit path input at lens 50 to optical fiber port 38 comprises contiguous regions of optical coupling system 12 that are devoid of air gaps. (The term “contiguous” as used herein refers to regions that are immediately adjacent to one another with no other regions interposed therebetween, such that an optical output of one of two contiguous regions is an optical input of the other of the two contiguous regions along the transmit and receive paths). It is especially useful for the region of upper portion 28 between RAF lens 40 and optical fiber port 38 to be devoid of air gaps in order to inhibit Fresnel reflection.

The transmit path has a monitor output defined in the exemplary embodiment by yet another lens 54 formed on a surface of lower portion 30. Monitor light detector 22 is aligned (along its optical axis) with lens 54 and thus aligned with the monitor output. First optical filter 32 is partially reflective to the transmit wavelength (λ1). Therefore, in operation, a portion (e.g., less than or equal to about 50 percent) of the optical energy of the transmit signal is reflected by first optical filter 32. This reflected portion of the transmit signal continues along another portion of the transmit path through a region of lower portion 30 and is incident on lens 54. Lens 54 focuses this portion of the transmit signal onto monitor light detector 22.

The receive path includes optical fiber port 38, RAF lens 40, at least portion of first optical filter 32, at least a portion of second optical filter 34, and the receive path output (defined by lens 52). Thus, in operation, the receive signal propagates from optical fiber 36 into optical coupling system 12 through optical fiber port 38. RAF lens 40 reflects the receive signal. The receive signal reflected by RAF lens 40 propagates along the receive path through a region of upper portion 28 to first optical filter 32. First optical filter 32 is substantially reflective to the receive wavelength (λ2). Therefore, a substantial proportion (e.g., at least about 90 percent) of the optical energy of the receive signal that is incident on first optical fiber 32 is reflected by first optical filter 32. The receive signal reflected by first optical filter 32 continues to propagate along the receive path through a region of upper portion 28 that can include reflective surfaces 56 and 58. Reflective surfaces 56 and 58 redirect the receive signal to second optical filter 34.

Second optical filter 34 is substantially transparent to the receive wavelength (λ2) but substantially reflective to the transmit wavelength (λ1). An undesirable crosstalk signal representing a portion of the transmit signal energy reflected by the end face of optical fiber 36 or by monitor light detector 22 may be incident on second optical filter 34. Second optical filter 34 blocks any such undesirable crosstalk signal by reflecting it. Therefore, a substantial proportion (e.g., at least about 90 percent) of the optical energy of the receive signal that is incident on second optical filter 34 is transmitted through second optical filter 34, whereas a substantial proportion (e.g., at least about 90 percent) of any undesirable crosstalk signal that is incident on second optical filter 34 is reflected by second optical filter 34 so as not to interfere with the detection of the receive signal by primary light detector 20. The receive signal that is transmitted through second optical filter 34 propagates along the transmit path through a region of lower portion 30 to lens 52, which focuses the receive signal upon primary light detector 20.

Note that the transmit path and receive path overlap in some regions of optical coupling system 12. Accordingly, it can be noted that optical fiber port 38, first optical filter 32 and RAF lens 40 are included in both the transmit path and the receive path, while second optical filter 34 is included only in the receive path.

In the exemplary embodiment, each of the above-described elements, including optical fiber port 38, RAF lens 40, first optical filter 32, second optical filter 34, light source 18, primary light detector 20, monitor light detector 22, lens 50, lens 52 and lens 54, represents one instance of such an element in an array (not shown for purposes of clarity) of such elements. The arrays extend in a direction perpendicular to the line along which FIG. 2 is sectioned. Thus, for example, RAF lens 40 is included in an array 60 of such RAF lenses, as indicated in FIG. 1. Each RAF lens in array 60 corresponds to one fiber in optical ribbon cable 16, one light source in an array (not shown) of such light sources, one primary light detector in an array of such primary light detectors (not shown), one monitor light detector in an array of such monitor light detectors (not shown), one first optical filter in an array of such first optical filters (not shown), one second optical filter in an array of such second optical filters (not shown), etc.

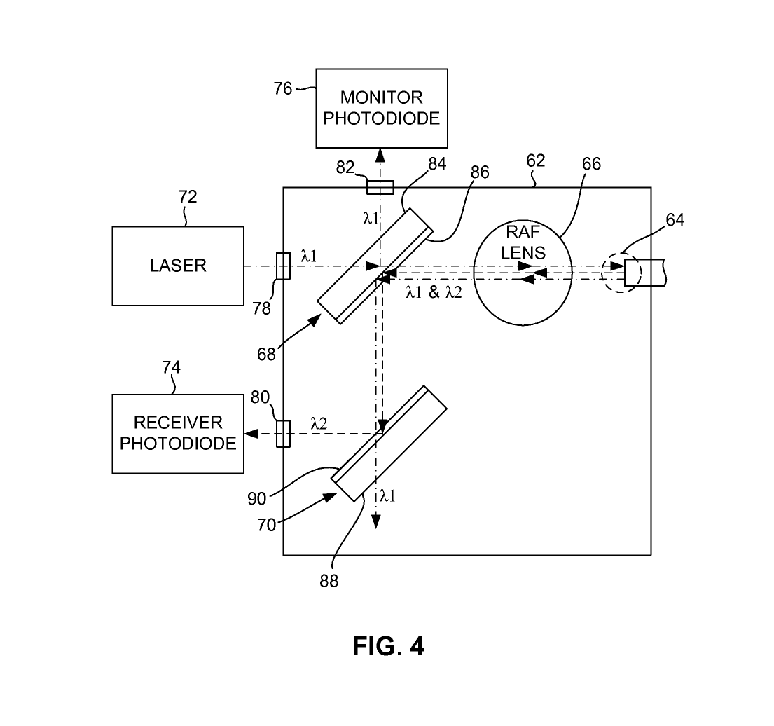

As illustrated in a schematic manner in FIG. 4, in another exemplary embodiment, an optical coupling system 62 includes an optical fiber port 64, an RAF lens 66, a first optical filter 68, a second optical filter 70, a light source 72 such as a laser, a primary light detector 74 such as a photodiode, a monitor light detector 76 such as another photodiode, a lens 78 or other transmit path input, a lens 80 or other receive path output, and a lens 82 or other transmit path output. As the characteristics of the transmit path and receive path in this embodiment (FIG. 4) can be the same as those described above with regard to the embodiment illustrated in FIGS. 2-3, for purposes of brevity such characteristics are not described again with regard to this embodiment. It should be noted that optical coupling system 62 can comprise any number of regions of any suitable shapes and materials, arranged in any suitable manner with regard to each other, such that the transmit path and receive path can have any suitable geometric configurations. For example, although not shown for purposes of clarity, optical coupling system 62 can include additional reflective surfaces similar to above-described reflective surfaces 56 and 58 that redirect one or both of the transmit and receive signals. Also, as light source 72, primary light detector 74, monitor light detector 76, RAF lens 66, and optical fiber port 64 can have the same characteristics in this embodiment as those of light source 18, primary light detector 20, monitor light detector 22, RAF lens 40, and optical fiber port 38, respectively, for purposes of brevity such characteristics are not described again with regard to this embodiment.

First optical filter 68 can comprise a glass substrate 84 having a dielectric coating 86 that is substantially transparent (e.g., greater than or equal to about 50 percent) to the transmit wavelength but also partially reflective to the transmit wavelength (e.g., less than or equal to about 50 percent) to the transmit wavelength. Therefore, a substantial proportion (e.g., at least about 50 percent) of the optical energy of the transmit signal is transmitted through first optical filter 68 to optical fiber port 64 via RAF lens 66, while another portion of the optical energy of the transmit signal is reflected by first optical filter 68 to monitor light detector 76 via lens 82 (transmit path output). The dielectric coating of first optical filter 68 is also substantially reflective to the receive wavelength (e.g., greater than or equal to about 90 percent). Therefore, a correspondingly substantial proportion of the optical energy of the receive signal is reflected in a direction that causes it to be incident on second optical filter 70.

Second optical filter 70 can comprise a glass substrate 88 having a dielectric coating that is substantially reflective (e.g., greater than or equal to about 90 percent) to the receive wavelength and substantially transparent to the transmit wavelength (e.g., greater than or equal to about 90 percent). Therefore, a substantial proportion (e.g., at least about 90 percent) of the optical energy of the receive signal is reflected by second optical filter 70 to primary light detector 74 via lens 80 (receive path output), while any portion of the optical energy of the transmit signal that represents undesirable crosstalk is transmitted through second optical filter 70 so as not to interfere with the detection of the receive signal by primary light detector 74.

It should be noted that the invention has been described with respect to illustrative embodiments for the purpose of describing the principles and concepts of the invention. The invention is not limited to these embodiments. As will be understood by those skilled in the art in view of the description being provided herein, many modifications may be made to the embodiments described herein without deviating from the goals of the invention, and all such modifications are within the scope of the invention.

What is claimed is:

1. An optical transceiver module comprising:
a light source configured to emit an optical transmit signal having a transmit wavelength along a first light source optical axis;
a first light detector configured to detect an optical receive signal having a receive wavelength along a first light detector optical axis; and
an optical coupling system, the optical coupling system including an optical fiber port, a reflective-and-focusing (RAF) lens, and a first optical filter substantially reflective to one of the transmit wavelength and the receive wavelength and substantially transparent to the other of the transmit wavelength and the receive wavelength, the optical coupling system defining a transmit path and a receive path, the transmit path being formed within one or more contiguous regions of the optical coupling system transparent to the transmit wavelength, the receive path being formed within the one or more contiguous regions of the optical coupling system and transparent to the receive wavelength, the optical fiber port being included in the transmit path and the receive path and having an optical fiber axis, the first optical filter being included in the transmit path and the receive path, and the RAF lens being included in the transmit path and the receive path and optically aligned with the optical fiber axis, a region in the transmit path and receive path between the RAF lens and the optical fiber port being devoid of air gaps, the light source optical axis aligned along an input of the transmit path, and the first light detector optical axis aligned along an output of the receive path.

2. The optical transceiver module of claim 1, further comprising a second optical filter included in the receive path and substantially transparent to the receive wavelength and substantially reflective to the transmit wavelength.

3. The optical transceiver module of claim 2, wherein the second optical filter is at least about 90 percent reflective to the transmit wavelength and at least about 90 percent transparent to the receive wavelength.

4. The optical transceiver module of claim 2, wherein:
the first optical filter is substantially transparent to the transmit wavelength and substantially reflective to the receive wavelength;
a first portion of the receive path includes the optical fiber port, a first interface of the first optical filter, and a first interface of the second optical filter; and
a second portion of the receive path includes the output of the receive path and a second interface of the second optical filter.

5. The optical transceiver module of claim 4, wherein:
the output of the receive path comprises a refractive lens; and
the input of the transmit path comprises a refractive lens.

6. The optical transceiver module of claim 1, further comprising a second optical filter included in the receive path and substantially reflective to the receive wavelength and substantially transparent to the transmit wavelength.

7. The optical transceiver module of claim 6, wherein the second optical filter is at least about 90 percent reflective to the transmit wavelength and at least about 90 percent transparent to the receive wavelength.

8. The optical transceiver module of claim 6, wherein:
the first optical filter is substantially transparent to the transmit wavelength and substantially reflective to the receive wavelength;
a first portion of the receive path includes the optical fiber port, a first interface of the first optical filter, and a first interface of the second optical filter; and
a second portion of the receive path includes the output of the receive path and a second interface of the second optical filter.

9. The optical transceiver module of claim 8, wherein:
the output of the receive path comprises a refractive lens; and
the input of the transmit path comprises a refractive lens.

10. The optical transceiver module of claim 1, further comprising a second light detector configured to detect a monitored portion of the optical transmit signal having the transmit wavelength along a second light detector optical axis aligned along a monitor output of the transmit path.

11. The optical transceiver module of claim 10, wherein:
the first optical filter is substantially transparent to the transmit wavelength and substantially reflective to the receive wavelength; and
a first portion of the transmit path includes the optical fiber port and a first interface of the first optical filter, and a second portion of the transmit path includes the input of the transmit path, the monitor output of the transmit path, and a second interface of the first optical filter.

12. The optical transceiver module of claim 11, wherein:
the monitor output of the transmit path comprises a refractive lens; and
the input of the transmit path comprises a refractive lens.

13. The optical transceiver module of claim 1, further comprising:
an optical fiber having an end face within the optical fiber port, wherein the optical fiber port comprises a bore; and
a refractive index-matching material disposed within the bore and forming an interface devoid of air gaps between the end face of the optical fiber and the optical coupling system.

14. A method for optical communication in an optical transceiver module, the optical transceiver module comprising a light source, a first light detector, and an optical coupling system, the optical coupling system including an optical fiber port, a reflective-and-focusing (RAF) lens, and a first optical filter substantially reflective to one of the transmit wavelength and the receive wavelength and substantially transparent to the other of the transmit wavelength and the receive wavelength, the optical coupling system defining a transmit path and a receive path, the transmit path being formed within one or more contiguous regions of the optical coupling system transparent to the transmit wavelength, the receive path being formed within the one or more contiguous regions of the optical coupling system transparent to the receive wavelength, the method comprising:
the light source emitting an optical transmit signal having a transmit wavelength, the optical transmit signal incident upon an input of the transmit path;
the optical coupling system propagating the optical transmit signal along the transmit path from the input of the transmit path to the RAF lens via the first optical filter, the first optical filter being included in the transmit path;
the RAF lens reflecting and focusing the optical transmit signal to form a focused transmit signal, the focused transmit signal propagating from the RAF lens to an end face of an optical fiber retained in the optical fiber port without propagating through an air gap;
the end face of the optical fiber emitting an optical receive signal having a receive wavelength, the optical receive signal incident upon the RAF lens;
the optical coupling system propagating the optical receive signal along the receive path from the RAF lens to a output of the receive path via the first optical filter; and
the first light detector detecting the optical receive signal emitted from the output of the receive path.

15. The method of claim 14, wherein the optical coupling system propagating the optical receive signal along the receive path from the RAF lens to an output of the receive path comprises the optical coupling system propagating the optical receive signal along the receive path from the RAF lens to an output of the receive path via the first optical filter and a second optical filter, the second optical filter substantially transparent to the receive wavelength and substantially reflective to the transmit wavelength.

16. The method of claim 15, wherein the optical coupling system propagating the optical transmit signal along the transmit path from the input of the transmit path to the RAF lens via the first optical filter comprises the optical coupling system transmitting a first portion of the optical transmit signal through the first optical filter.

17. The method of claim 16, further comprising the optical coupling system reflecting a second portion of the optical transmit signal from the first optical filter to a second light detector via a monitor output of the transmit path.

18. The method of claim 14, wherein the optical coupling system propagating the optical receive signal along the receive path from the RAF lens to an output of the receive path comprises the optical coupling system propagating the optical receive signal along the receive path from the RAF lens to an output of the receive path via the first optical filter and a second optical filter, the second optical filter substantially reflective to the receive wavelength and substantially transparent to the transmit wavelength.

19. The method of claim 18, wherein the optical coupling system propagating the optical transmit signal along the transmit path from the input of the transmit path to the RAF lens via the first optical filter comprises the optical coupling system transmitting a first portion of the optical transmit signal through the first optical filter.

20. The method of claim 19, further comprising the optical coupling system reflecting a second portion of the optical transmit signal from the first optical filter to a second light detector via a monitor output of the transmit path.
